(19) United States
(12) Patent Application Publication
(10) Pub. No.: US 2018/0308178 A1
(43) Pub. Date: Oct. 25, 2018

(54) DECISION ENGINE

(71) Applicant: ServiceChannel.com, Inc., New York, NY (US)

(72) Inventors: Brian Matthew Engler, Higganum, CT (US); Siddarth Shridhar Shetty, Princeton, NJ (US)

(73) Assignee: ServiceChannel.com, Inc., New York, NY (US)

(21) Appl. No.: 15/961,315

(22) Filed: Apr. 24, 2018

Related U.S. Application Data
(60) Provisional application No. 62/489,276, filed on Apr. 24, 2017.

(51) Int. Cl. G06Q 40/00; G06N 5/02

(52) U.S. Cl. CPC G06Q 40/12; G06N 5/02

(57) ABSTRACT

Examples of the present disclosure describe systems and methods related to a decision engine. In an example, proposals, work orders, invoices, and assets may be managed by the decision engine, such that recommendations may be generated and automatic actions may be performed on behalf of a subscriber. For example, a model may be trained based on historical data, which may be used to generate recommendations as to whether proposal should be approved or rejected. In examples, the proposal may be presented along with additional information, such as asset information or information relating to similar proposals, thereby enabling improved decision making. In other examples, invoice approval rules may be generated based on the historical information applied to invoices as they are received from contractors, which reduces the amount of manual effort involved in approving and rejecting invoices.

### CROSS-REFERENCE TO RELATED APPLICATION

This application claims priority to U.S. Provisional Application No. 62/489,276, entitled “Decision Engine,” filed on Apr. 24, 2017, the entire disclosure of which is hereby incorporated by reference in its entirety.

### BACKGROUND

Aspects of the present disclosure relate to an automated decision engine for recommending an action, such as whether a proposal should be accepted or rejected. Aspects disclosed herein utilize historical data and advanced machine learning models to prescribe or recommend the action at the point of the decision.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods related to a decision engine. In an example, proposals, work orders, invoices, and assets may be managed by the decision engine, such that recommendations may be generated and automatic actions may be performed on behalf of a subscriber. For example, a model may be trained based on historical information or data, which may then be used to process proposals when they are received from contractors. Using the model, a recommendation as to whether the proposal should be approved or rejected may be generated. In examples, the proposal may be presented along with additional information, such as information relating to an asset with which the proposal is associated, or proposals that are determined to be similar to the instant proposal. Accordingly, the decision to approve or reject the proposal may be made based at least in part on the recommendation and the additional information. As a result, a subscriber may gain additional insight into the proposal and may make a more informed decision than would otherwise be possible.

In other examples, invoice approval rules may be applied to invoices as they are received from contractors, thereby reducing the amount of manual effort involved in approving and rejecting invoices. In some instances, historical invoice data may be analyzed in order to identify patterns and provide suggested invoice approval rules. Suggested invoice approval rules may then be approved or rejected by a subscriber. Thus, as a result of approving such rules, a subscriber may have more time to analyze invoices that are not routine, while such routine invoices may be automatically processed according to the invoice approval rules without further manual input.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system comprising a decision engine according to aspects disclosed herein.

FIG. 2 illustrates an example workflow for a decision engine.

FIG. 3A illustrates an overview of an example method for generating a recommendation based on a received proposal.

FIG. 3B illustrates an overview of an example method for training a model for generating recommendations.

FIG. 4 illustrates an overview of an example method for processing a received invoice.

FIG. 5 illustrates an overview of an example user interface for providing a recommendation according to aspects disclosed herein.

FIG. 6 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

In examples, managing proposals, work orders, invoices, and assets may be difficult. For example, the amount of information associated with managing such aspects of a business may make it challenging to devote the attention necessary. Additionally, ensuring decisions are made based on accurate, relevant, and current information may prove difficult in such an environment. Thus, decisions may be made based on inaccurate or unhelpful data, proposals may not be afforded the care required to ensure they are competitive, and repetitive manual tasks may consume time that could otherwise be used to focus on more important, impactful aspects of managing such data and processes.

Accordingly, an analytics platform is provided that takes historical data and uses it to build a predictive model that may automatically generate a recommended action at a decision point. For example, a model may be constructed that can generate recommendations related to whether proposal should be accepted or rejected. In another example, one or more rules may be generated and applied in order to automatically approve or reject invoices In some instances, a recommendation may be in the form of a binary recommendation (e.g., approve or reject) and/or a score (e.g., 1-100, 60%, etc.), among other types of recommendations. For ease of illustration, the disclosure will describe aspects related to providing proposal recommendations and generating rules for processing invoices. However, one of skill in the art will appreciate that the aspects disclosed herein may be utilized to generate other types of recommendations without departing from the spirit of this disclosure.

In one example, one or more individualized models may be built for each individual subscriber. The individualized models may be generated using a specific subscriber's historical data (e.g., work orders, proposals, invoices, assets, previous decisions to accept or reject proposals or invoices, etc.). In such aspects, an individualized model may be applied to each individual subscriber to generate one or more recommendations for the individual subscriber. Alternatively, a model may be generated that includes data from multiple subscribers (e.g., subscribers in similar industries, from similar regions, etc.). In such aspects, a single model or set of models may be applied to multiple such subscribers when generating a recommendation. In examples, the same model may be used for multiple subscribers while varying one or more weights of the model, wherein the weights may be subscriber-specific.

Key data points may be identified to build the model. Analysis of hundreds of data points may be performed in order to identify key data points that are statistically significant in making a recommendation (e.g., determining if a proposal should be approved or rejected). These key data points include, but are not limited to, information such as trade, proposal amount, provider scorecard grade, provider compliance score, and the like. One of skill in the art will appreciate that other data points may be practiced without departing from the scope of this disclosure. In certain aspects, the types of key data points may change depending upon the type of recommendation generated by the decision engine.

Once the model is constructed, training may be periodically performed. For example, data may be fed into the model on a weekly basis in order to tune the model for more accurate recommendations. Recommendations provided by the model may also be used for training, along with data related to whether the recommendation was accepted by the subscriber. In further examples, a continuous training approach may be employed. In the continuous training approach, each model (e.g., each model for the different customers) may be trained one at a time. Once all the models have been trained, the process may start over from the beginning and retrain each model in a continuous loop.

In certain aspects, a model may be tested after training. In such aspects, a set of data for a subscriber may be divided into a training subset and a verification subset. Accordingly, the training subset of data may be used to train the model. After training the model, the model may subsequently be verified using the data in the verification subset of data. In examples, testing may be performed to ensure that the recommendations generated by the model provide a certain level of accuracy and/or precision. If it is determined that the model fails to meet the desired accuracy or precision level, among other characteristics, additional training may be performed, and/or different model types or training techniques may be used.

Once a model has been constructed, the decision engine may use the model to generate recommendations for a subscriber. In certain aspects, data may be provided to the model in real-time in order to generate a recommendation. For example, a contractor may submit a proposal to the system. As an example, a contractor may be a landscaper, a plumber, an electrician, or a construction company, among other examples. Detailed information about the new proposal may be fed into the model in order to generate a recommendation (e.g., acceptance or rejection of the proposal). In examples, the recommendation may comprise a percentage or other value relating to a probability of acceptance for the proposal. The recommendation is then displayed to a customer along with additional information that may be helpful when determining whether to approve or reject the proposal. For example, the additional information may relate to an asset associated with the proposal (e.g., amount of dollars spent maintaining the asset, life expectancy, estimated replacement cost, a summary of proposals and/or work orders, etc.) and/or comparison information (e.g., past proposals for similar tasks, proposals for similar tasks and/or subscribers, etc.), among other information. While example asset information is described herein, it will be appreciated that a variety of other information may be used, such as age, an type, remaining warranty period, condition, and/or completed or pending work orders.

In examples, the model may also be used to automatically approve proposals. A customer may define certain criteria that, if met, allow the recommendation generated by the model to be used by the decision engine to automatically approve or reject proposals based upon evaluation. For example, criteria may include information such as the type of proposals, a price, a confidence score, and the like. In other examples, one or more invoices may be received from contractors, which may be automatically approved or rejected based on rules. The decision engine may evaluate historical data to generate suggested rules that may be selected or enabled by a subscriber, so as to automatically approve or reject invoices satisfying the generated rules. In another example, a subscriber may manually create a rule or may revise an automatically generated rule suggestion.

When generating proposal recommendations, various types of input may be received and/or accessed by the decision engine. Example types of input include, but are not limited to, invoices, work orders, contractor information, rates, trade, category, priority, feedback, etc. In examples, the decision engine may analyze the input and may apply various machine learning processes including, but not limited to, decision trees, association rules, neural networks, deep learning, and the like, to generate a recommendation. For example, a probability of approval for a proposal may be predicted using logistic regression.

After generating a probability of approval for one or more proposals, the decision engine may use a predicted probability to determine a recommendation. For example, the determined recommendation may be to approve a proposal or reject a proposal. As discussed above, it will be appreciated that a recommendation may take any of a variety of forms. In addition to determining and providing the recommendation, additional information may be also be provided by the decision engine. For example, information about the input driving the probability calculation and recommendation may be provided (e.g., type of proposal, cost, provider info, etc.). In one example, the recommendation may be provided to a user for acceptance or refusal of the recommendation. Alternatively, a decision may be automatically made by the decision engine based upon the determined recommendation and/or automation rules. For example, if a recommendation generated by the recommendation engine has a high level of confidence (e.g., higher than a predetermined threshold), the decision engine may automatically employ the recommendation to approve or reject the proposal without requiring user input.

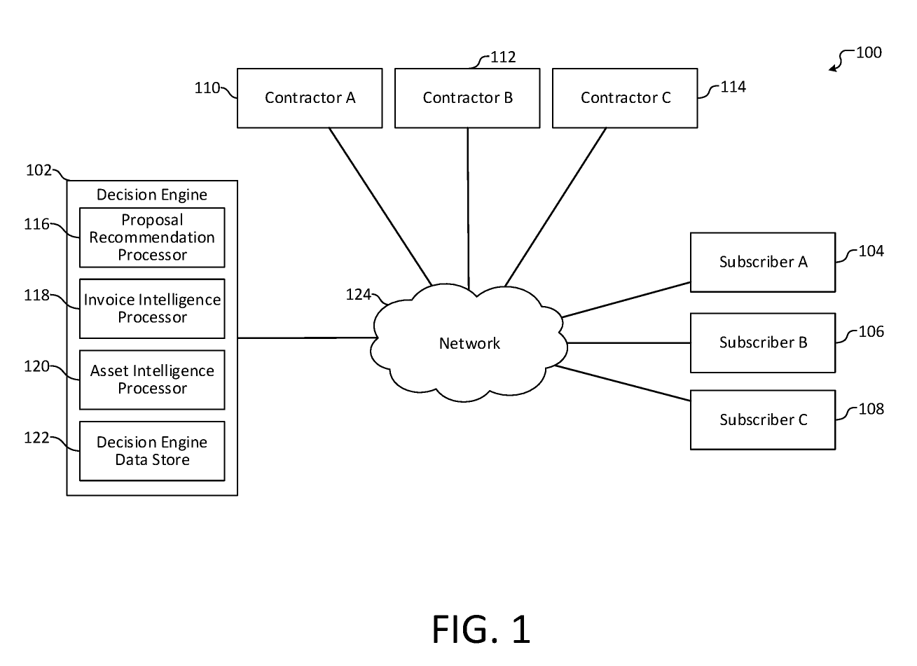

FIG. 1 illustrates an overview of an example system 100 comprising a decision engine according to aspects disclosed herein. As illustrated, system 100 comprises decision engine 102, subscribers 104-108, contractors 110-114, and network 124. In examples, subscribers 104-108 may use decision engine 102 to manage proposals, work orders, invoices, and the like. Accordingly, at least one of contractors 110-114 may submit proposals, respond to work orders, and submit invoices to decision engine 102 for processing. Decision engine 102 may process such information received from contractors 110-114 in order to generate recommendations and/or automatically approve or reject invoices, among other operations, according to aspects disclosed herein. In some examples, contractors 110-114 and subscribers 104-108 may interact with decision engine 102 via network 124, through a web interface, using a desktop or mobile application, or any of a variety of other techniques.

As illustrated, decision engine 102 comprises proposal recommendation processor 116, invoice intelligence processor 118, asset intelligence processor 120, and decision engine data store 122. According to aspects disclosed herein, proposal recommendation processor 116 may use a model to evaluate one or more proposals received by decision engine 102 from contractors 110-114 in order to generate a proposal recommendation. In examples, one of contractors 110-114 may submit a proposal to decision engine 102 (e.g., via a web interface, using a desktop or mobile application, etc.). The proposal may comprise an estimated task duration, an estimated cost, etc. In some examples, the proposal may be associated with an asset and/or may comprise a problem code. The problem code may comprise information relating to a problem associated with the proposal. For example, a problem code may comprise a hierarchical classification of the problem, such that similar proposals may be associated with similar problem codes.

Invoice intelligence processor 118 may be used to process invoices received by decision engine 102 from contractors 110-114 in order to automatically approve or reject such invoices. In an example, one or more invoice approval rules may be specified for a subscriber (e.g., manually, automatically, etc.) that may be applied to an invoice when the invoice is received from a contractor. For example, an invoice approval rule may specify any of a variety of criteria, including, but not limited to, one or more specific contractors, a threshold cost, one or more assets associated with the invoice, etc. Accordingly, invoices that would ordinarily be manually reviewed may instead be automatically processed, thereby reducing the amount of manual effort required for such potentially repetitive tasks. In another example, invoice intelligence processor 118 may evaluate historical invoices associated with a subscriber to determine whether there are any invoice approval rules that may be suggested to a subscriber and/or automatically generated. The evaluation may comprise any of a variety of machine learning techniques to identify patterns within the historical invoices.

Asset intelligence processor 120 may generate intelligence regarding one or more assets associated with subscribers 104-108. For example, an asset may be a machine, an article of furniture, etc. Asset intelligence processor 120 may maintain or generate information relating to historical work orders, proposals, and/or invoices associated with assets of subscribers 104-108. Accordingly, information from asset intelligence processor 120 may be used when a user is determining whether to accept or reject a proposal, among other instances.

Decision engine data store 122 may store a variety of information associated with subscribers 104-108 and/or contractors 110-114. For example, proposals, work orders, and/or invoices may be stored, thereby facilitating the analysis and processing described herein (e.g., as may be performed by proposal recommendation processor 116, invoice intelligence processor 118, asset intelligence processor 120, etc.). Information associated with contractors 110-114 may also be stored, including, but not limited to, rating information, efficiency metrics, and the like.

Accordingly, information from decision engine data store 122 may be used by proposal recommendation processor 116 when training models and when generating proposal recommendations. In some examples, information from asset intelligence processor 120 may be displayed in combination with a generated proposal recommendation, thereby providing additional information that can be used when determining whether to accept or reject a proposal. As discussed above, information relating to an asset associated with the proposal may be displayed, among other additional information.

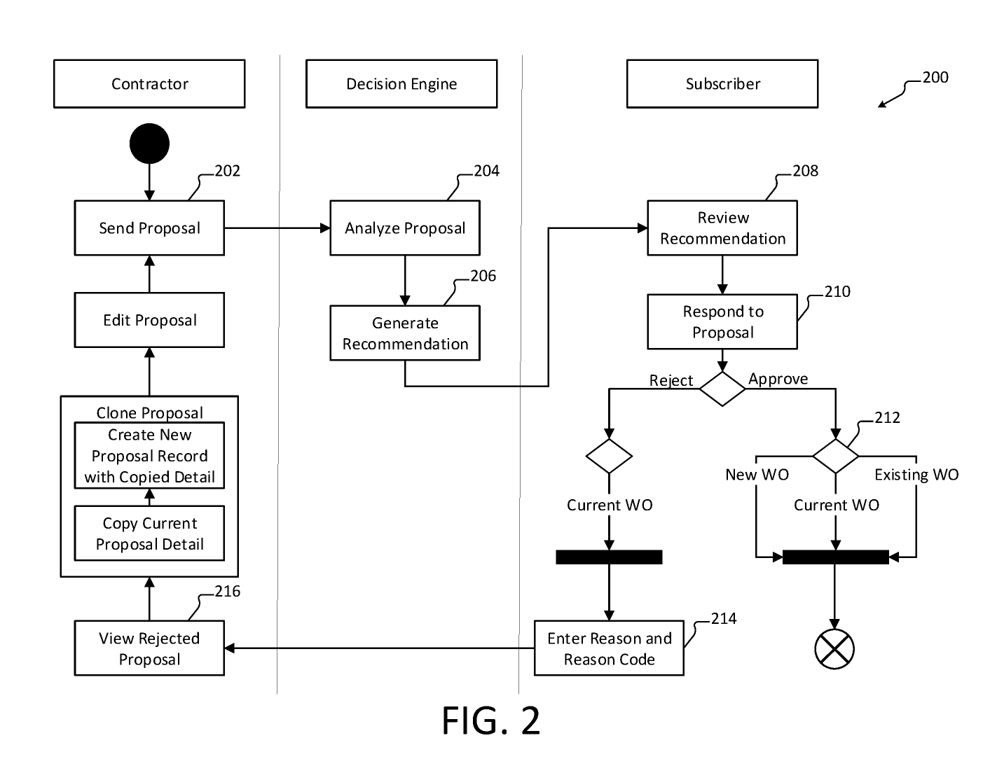

FIG. 2 illustrates an example workflow 200 for a decision engine. For ease of illustration, example workflow 200 is described with respect to generating a recommendation and/or decision as to whether or not a proposal should be accepted. However, one of skill in the art will appreciate that other types of proposals or recommendations may be generated by the aspects disclosed herein. Flow begins at operation 202, where a proposal may be submitted by a contractor (e.g., one of contractors 110-114 in FIG. 1) to the decision engine (e.g., decision engine 102). In one example, the proposal may be electronically submitted to the decision engine via an online portal. Alternatively, the proposal may be submitted via other forms of electronic communication. In examples, the decision engine may store the proposal in a decision engine data store, such as decision engine data store 122 in FIG. 1.

Flow proceeds to operation 204, where the proposal may be analyzed by the decision engine (e.g., using a proposal recommendation processor, such as proposal recommendation processor 116 in FIG. 1). As described above, the proposal may be analyzed using one or more models and/or machine learning techniques. Based on the analysis, a recommendation may be generated at operation 206. The recommendation may be to accept the proposal, reject the proposal, or an indication that a recommendation cannot be made. In another example, the recommendation may comprise a numeric score or a probability, etc. In addition to the recommendation, other information may be generated about the proposal or accessed by the decision engine at operation 206 (e.g., asset information for an asset associated with the proposal, historical or comparable proposals, etc.). The recommendation and/or additional information may then be provided to a subscriber for review at operation 208.

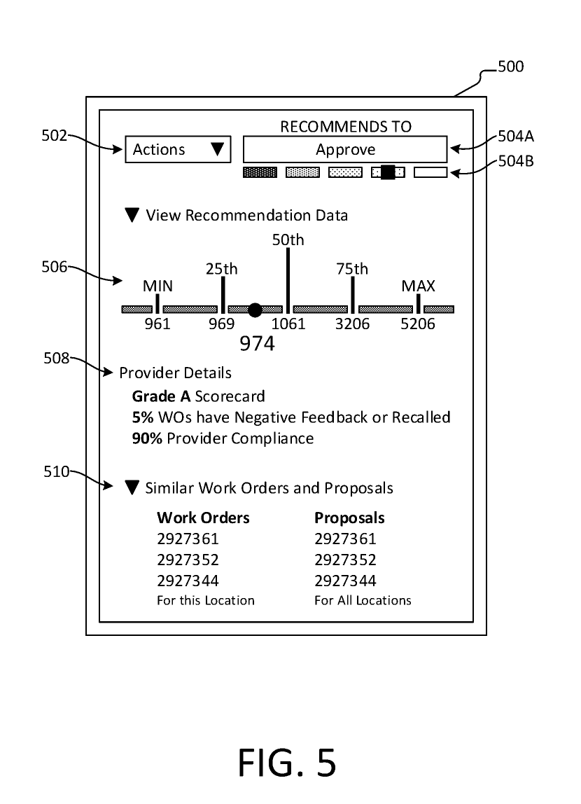

At operation 208, a proposal recommendation may be provided to a subscriber. FIG. 5, which is discussed in greater detail below, provides an example user interface for providing a recommendation. As depicted in FIG. 5, a recommendation may be provided to the subscriber along with an indication of the strength of the recommendation. In some examples, the strength of the recommendation may be indicated using a sliding scale. Alternatively, a confidence value may be displayed. As described herein, additional information may also be displayed along with the recommendation, such as comparison data to other submitted proposals, information about the proposal provider, and/or links to similar work orders or proposals.

Returning to FIG. 2, upon providing the recommendation for review to the subscriber, action based on the recommendation may be taken at operation 210. In one aspect, the action taken at 210 may be an indication that the subscriber has accepted or rejected the proposal. Alternatively, an action to accept or reject the proposal may be automatically performed at operation 210 by the decision engine without further subscriber input. If the decision is accepted, flow branches “Approve” to operation 212, where the approval of the proposal may be transmitted to the contractor. In various aspects, the proposal may be approved along with a current or existing work order provided by the contractor. Alternatively, a modified work order may be approved and submitted to the contractor.

Returning to operation 210, if the proposal is rejected, flow instead branches “Reject” to operation 214, where a reason and reason code may be entered and a refusal notification may be generated and provided to the contractor. In certain aspects, the refusal notification may contain additional information as to one or more reasons why the proposal was rejected, or may not contain such information. The rejection notification may be viewed by the contractor at operation 216. In various aspects, the contractor may be able to submit a new proposal or adjust the proposal and resubmit the proposal to the decision engine. In such aspects, flow returns to operation 202 where the new proposal may be submitted or the current proposal may be resubmitted to the decision engine.

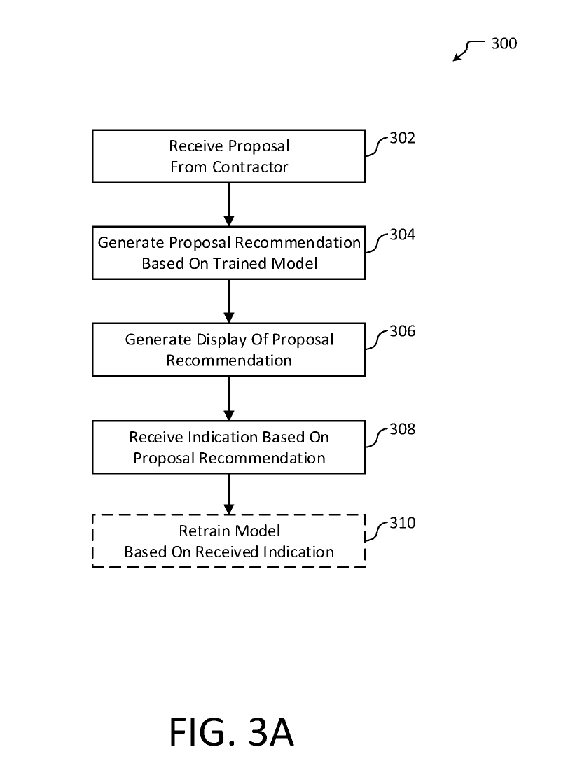

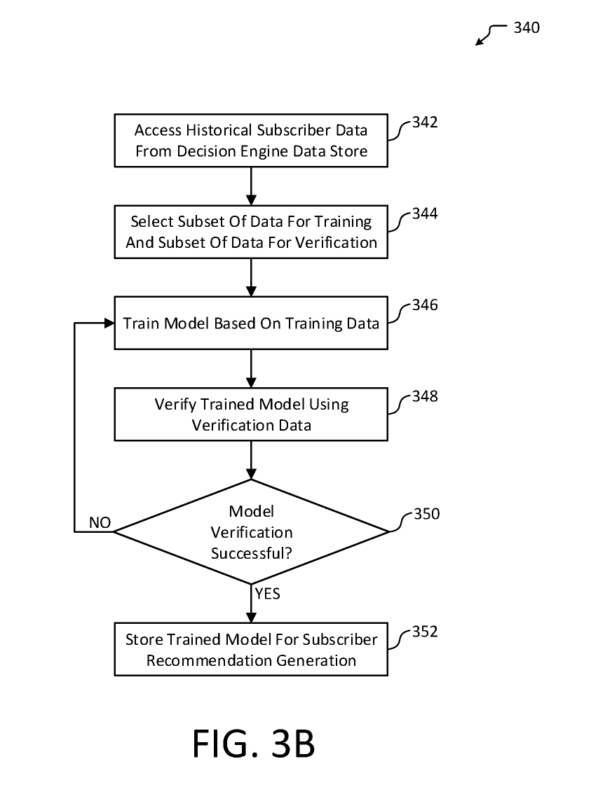

FIG. 3A illustrates an overview of an example method 300 for generating a recommendation based on a received proposal. In an example, aspects of method 300 may be performed by a decision engine, such as decision engine 102 in FIG. 1. Method 300 begins at operation 302, where a proposal may be received from a contractor. In examples, the proposal may be received from a web interface, as part of an electronic communication, or from a mobile or desktop application, among other examples. In some examples, the proposal may be associated with an asset and/or may comprise a problem code as described herein.

Flow progresses to operation 304, where a proposal recommendation may be generated based on a trained model. As an example, a model may be trained based on historical data associated with a subscriber. In another example, the model may be trained based on historical data associated with multiple subscribers. In such examples, historical data from multiple subscribers may be used in order to provide recommendations in accordance with best practices for an industry, or in order to ensure the model does not reinforce potentially unwise or generally detrimental past behavior on the part of the subscriber, among other reasons. As discussed above, the generated recommendation may be in the form of “approve” or “reject,” may comprise a score, or may comprise a probability of acceptance, among other recommendations.

At operation 306, a display of the proposal recommendation may be generated for presentation to a subscriber. In examples, presenting the display may comprise transmitting the generated display to a computing device. The display may comprise additional information useable to determine whether to accept or reject the proposal. Example additional information includes, but is not limited to, information relating to an asset associated with the proposal (e.g., amount of dollars spent maintaining the asset, life expectancy, estimated replacement cost, a summary of proposals and/or work orders, etc.) and/or comparison information (e.g., past proposals for similar tasks, proposals for similar tasks and/or subscribers, etc.), among other information. In examples, the comparison information may be identified based on an analysis of a problem code associated with the proposal and problem codes associated with historical information. An example proposal recommendation display is depicted in FIG. 5.

Moving to operation 308, an indication may be received based on the proposal recommendation. In an example, the indication may be received from a web interface, a mobile application, or a desktop application, among other sources. In another example, the indication may be received as a result of a user clicking a link in an email comprising the display that was generated at operation 306. The indication may indicate whether the proposal is accepted or rejected. In some examples, the indication may comprise additional information regarding why the proposal was accepted or rejected, which may be provided to the contract and/or used to train and/or retrain a model.

At operation 310, the trained model may be retrained based on the indication that was received at operation 308. Operation 310 is illustrated using a dashed box to indicate it is an optional step. In some examples (e.g., where the generated recommendation was accepted), the model may not be retrained. In other examples (e.g., where the generated recommendation was not accepted, where additional information was provided as part of the indication regarding why the proposal was accepted or rejected, etc.), operation 310 may be performed in order to continually adapt the model and improve the models effectiveness. In another example, operation 310 may be performed both in instances where a recommendation is accepted and instances where a recommendation is rejected. In such examples, a rejected recommendation may be more heavily weighted than an accepted recommendation when retraining the model. Flow terminates at operation 310 or, in some instances, at operation 308.

FIG. 3B illustrates an overview of an example method 340 for training a model for generating recommendations. In an example, aspects of method 340 may be performed by a decision engine, such as decision engine 102 in FIG. 1. Method 340 begins at operation 342, where historical subscriber data may be accessed from a decision engine data store, such as decision engine data store 122 in FIG. 1. In an example, the accessed historical subscriber data may be associated with a single subscriber or may be associated with multiple subscribers (e.g., of a similar industry, located in a similar geographic region, etc.).

Flow progresses to operation 344, where a subset of data may be selected for training and a subset of data may be selected for verification. In some examples, data may be selected randomly, or based on one or more criteria (e.g., quantity of similar data, deviation of the data from one or more averages, recency of the data, etc.). In other examples, data may be relatively evenly apportioned between training and verification, or may be apportioned such that more data is used for training while less is used for verification, or vice versa. In another example, the subset of data for training may comprise data that is also in the subset of data for verification, or the subset of data for verification may comprise data that is also in the subset of data for training.

At operation 346, a model may be trained based on the subset of data for training. In examples, a machine learning algorithm may be selected from a set of machine learning algorithms, such that different algorithms may be used for different sets of data. For example, the selected algorithm may be an algorithm that is expected or known to be better-suited to the data that other algorithms. While examples herein are discussed with respect to training a model based on historical subscriber data, it will be appreciated that, in some examples, information relating to one or more contractors may also be used. For example, information regarding to a contractor's feedback score, compliance information, and/or general scorecard information, among other information, may be used.

Moving to operation 348, the model that was generated at operation 346 may be verified using the subset of verification data that was selected at operation 344. As an example, aspects of the selected verification data may be used as inputs to the trained model, and the result may be compared to the known result associated with the inputs. Accordingly, it may be possible to determine an accuracy percentage for the trained model based on the subset of historical sub scriber data.

At determination 350, it may be determined whether model verification was successful. In some examples, the determination may comprise comparing the determined accuracy percentage to a threshold. For example, if the accuracy is above 80% or 90%, it may be determined that the model has been verified successfully. However, if the accuracy is below such a threshold, model verification may not be successful.

If model verification is not successful, flow branches “NO” to operation 346, where the model may be retrained or a new model may be trained (e.g., based on a different algorithm or, in some examples, based on different weights or a different subset of data, etc.). However, if model verification is successful, flow instead branches “YES” to operation 352, where the trained model may be stored for later use when generating recommendations. While method 340 is discussed with respect to training a model, it will be appreciated that similar techniques may be used to determine one or more weights useable with the same model, such that multiple subscribers may use the same model with subscriber-specific weights. Flow terminates at operation 352.

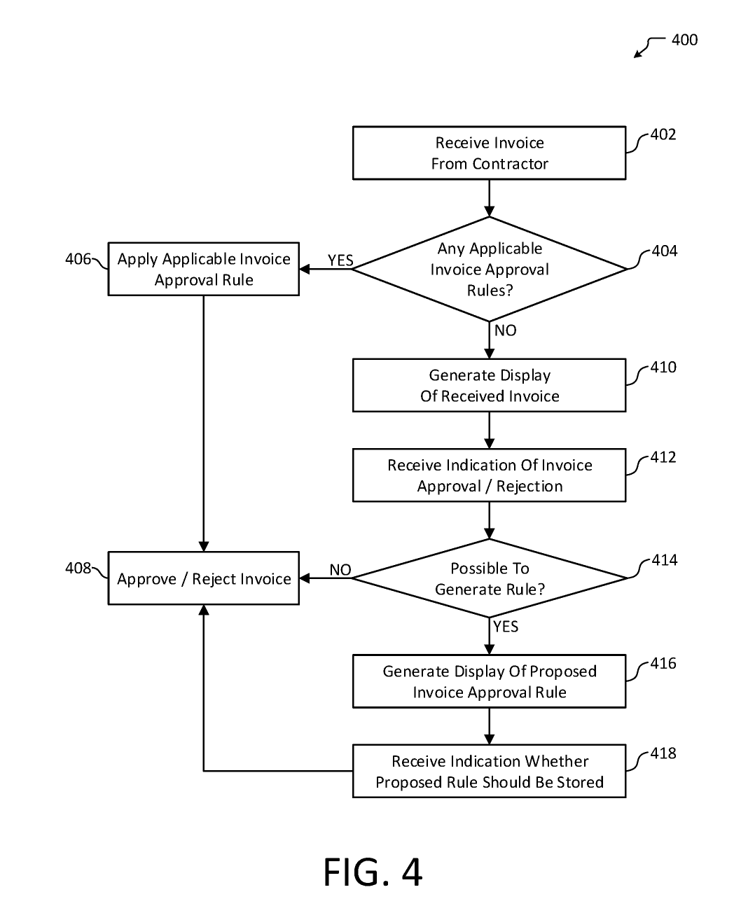

FIG. 4 illustrates an overview of an example method 400 for processing a received invoice. In an example, aspects of method 400 may be performed by a decision engine, such as decision engine 102 in FIG. 1. Method 400 begins at operation 402, where an invoice may be received from a contractor. In examples, the invoice may be received from a web interface, as part of an electronic communication, or from a mobile or desktop application, among other examples. In some examples, the invoice may be associated with an asset as described herein.

Flow progresses to determination 404, where it may be determined whether there are any applicable invoice approval rules. In an example, the determination may comprise accessing a set of invoice approval rules (e.g., from a decision engine data store, such as decision engine data store 122 in FIG. 1) and evaluating each of the rules to determine whether any of the rules are applicable to the invoice. An invoice approval rule may specify any of a variety of criteria useable to determine whether the rule is applicable, including, but not limited to, a contractor (e.g., using a name, unique identifier, etc.), an asset, an amount, a trade, a category, whether the invoice has an attachment, whether the invoice is associated with an approved proposal, or a problem code.

If it is determined that there is an applicable invoice approval rule, flow branches “YES” to operation 406, where the one or more applicable invoice approval rules may be applied to the received invoice. For example, an invoice approval rule may indicate that the received invoice may be automatically approved or rejected, or that one or more corrections should be automatically applied to the invoice, among other rules. Flow then progresses to operation 408, where the invoice may be approved or rejected, depending on the invoice approval rules that were applied. Flow terminates at operation 408.

If, however, it is determined at determination 404 that there are not any applicable invoice approval rules, flow instead branches “NO” to operation 410, where a display of the received invoice may be generated. In an example, the display may be presented using a web interface, as part of an electronic communication, via a mobile or desktop application, etc. In some examples, the display may comprise additional information, including, but not limited to, similar historic invoices and whether they were approved or rejected, information for an asset associated with the invoice (e.g., amount of dollars spent maintaining the asset, life expectancy, estimated replacement cost, a summary of proposals and/or work orders, etc.), and/or information associated with the contract (e.g., a score report, a ranking within an industry, etc.).

At operation 412, an indication may be received as to whether the invoice is approved or rejected. In some examples, the indication may comprise information relating to why the invoice was approved or rejected, which may be stored for later analysis and/or communicated to the contractor from which the invoice was received. While examples are discussed herein with respect to approving or rejecting an invoice, it will be appreciated that similar techniques may be applied for additional, alternative, or fewer actions. For example, an invoice may be held or returned, among other actions.

At determination 414, it may be determined whether it is possible to generate an invoice approval rule associated with the invoice based on the indication that was received at operation 412. For example, it may be determined that a pattern is identifiable associated with the received invoice and one or more similar historical invoices. As another example, it may be determined that a general behavior pattern exists (e.g., the user always approves invoices under a certain dollar amount, the user always approves invoices for a certain task or relating to a certain asset, etc.). If it is determined that it is not possible to generate a rule, flow branches “NO” to operation 408, where the invoice may be approved or rejected based on the indication received at operation 412. Flow terminates at operation 408.

If, however, it is determined that it is possible to generate an invoice approval rule, flow progresses to operation 416, where a display of the proposed invoice approval rule may be generated. In an example, the display may comprise a basis for providing the recommended invoice approval rule (e.g., a summary of historical invoices that were at least used in part when generating the recommended invoice approval rule, an indication that other similar subscribers have instituted such a rule, etc.). In another example, the display may comprise an interface useable to edit the proposed invoice approval rule.

At operation 418, an indication may be received as to whether the proposed rule should be stored. The indication may comprise a reason as to why the rule was accepted or rejected. In another example, the indication may comprise one or more modifications to the proposed invoice approval rule. If it is indicated that the rule should be stored, the invoice approval rule may be stored in a decision engine data store, such as decision engine data store 122 in FIG. 1. If it is indicated that the rule should not be stored, information associated with the rule and the indication may be stored for later use when generating subsequent invoice approval rules, such that similar invoice approval rules may not be generated, or such that more relevant and/or useful invoice approval rules may be generated for the subscriber.

Flow continues to operation 408, where the invoice may be approved or rejected based on the indication received at operation 412. While example invoice approval rules are discussed herein, it will be appreciated that any of a variety of other criteria and/or actions may be used without departing from the scope of this disclosure. Flow terminates at operation 408.

FIG. 5 illustrates an overview of an example user interface (UI) 500 for providing a recommendation according to aspects disclosed herein. In an example, UI 500 may be displayed on a screen of a computing device, including, but not limited to, a mobile device, a desktop device, a laptop device, or a table device. In some examples, UI 500 may be provided as part of a web interface of a web application, as part of a mobile application, as part of a desktop application, or in an electronic communication.

As illustrated, UI 500 comprises actions dropdown 502, which may provide one or more actions that may be performed on the proposal. For example, approve, reject, modify, etc. UI 500 also comprises recommendation 504A-B, which may be generated according to aspects disclosed herein. Recommendation 504A comprises a textual description (i.e., “Approve”) of the recommendation. In other examples, recommendation 504B may read “Strongly Approve,” “Reject,” “Strongly Reject,” or, in instances where the model does not offer sufficient certainty, “Not Enough Data” or “No Recommendation.” Recommendation 504B provides a visual indication as to the strength of the recommendation. For example, the black square may instead be located toward the left of the scale in instances where recommendation 504A reads “Reject.” While example recommendation UI elements are discussed, it will be appreciated that any of a variety of other techniques may be used to display a recommendation as may be generated according to aspects disclosed herein.

Recommendation data 506 may provide additional insight into the generated recommendation for the proposal. As illustrated, recommendation data 506 comprises a statistical distribution indicating where the proposal ranks in relation to other similar proposals. UI 500 further comprises provider details 508, which provides additional information associated with the contractor that provided the proposal. For example, scorecard information (i.e., “Grade A”), feedback information (i.e., “5% WOs have Negative Feedback or Recalled), and compliance information (i.e., “90% Provider Compliance”).

Finally, UI 500 comprises similar view 510, which may be used to view similar work orders and proposals. As described herein, similar work orders and proposals may be identified using any of a variety of techniques, including, but not limited to, a comparison based on problem codes, one or more associated assets, similar or the same contractors, etc. Thus, UI 500 comprises a recommendation (e.g., recommendation 504A-B) for a proposal, as well as additional information (e.g., recommendation data 506, provider details 508, and similar view 510). While example additional information is discussed with respect to UI 500, it will be appreciated that additional, alternative, or less additional information may be presented in other examples. For example, information for an asset associated with the proposal may be displayed.

UI 500 is provided as an example user interface for presenting recommendations generated according to aspects disclosed herein. However, it will be appreciated that UI 500 and other such examples may not merely present a generated recommendation, but may also serve to consolidate and process a variety of other useful generated information to provide a convenient and easily-understandable display, thereby facilitating improved decision-making and increased expediency when evaluating proposals. Indeed, UI 500 incorporates a variety of visual displays relating to the strength of the proposal (e.g., to aid a user's interpretation of the generated recommendation), information associated with a provider or contractor (e.g., to provide context), and a listing of similar work orders and proposals (e.g., to facilitate easy comparison of the instant proposal). As described above, other additional information may be provided, including, but not limited to, asset information and similar proposals for geographically similar subscribers. By contrast, using traditional solutions, it may be challenging, time-consuming, or simply impossible to gather and process such information from a variety of potential information sources in order to arrive at the same level of informed decision-making.

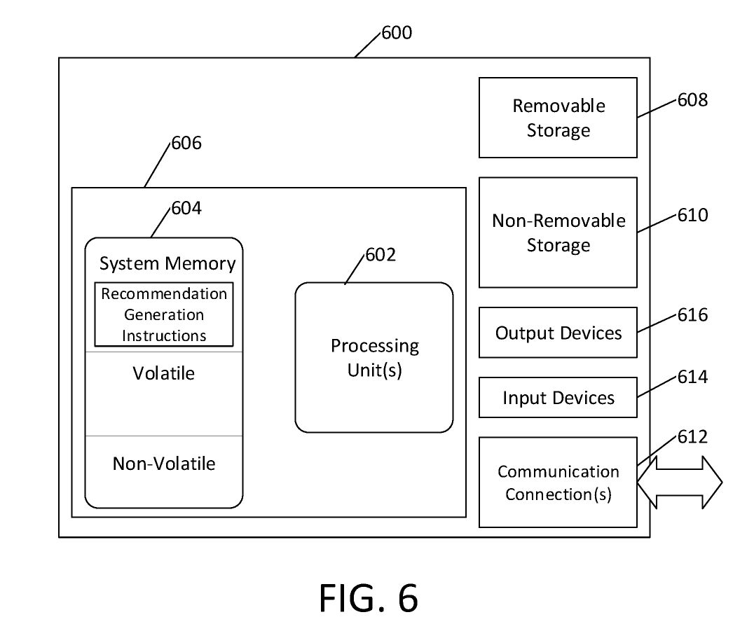

FIG. 6 illustrates an exemplary suitable operating environment for the decision engine described in herein. In its most basic configuration, operating environment 600 typically includes at least one processing unit 602 and memory 604. Depending on the exact configuration and type of computing device, memory 604 (storing, among other things, instructions to generate recommendations as disclosed herein) may be volatile (such as RAM), non-volatile (such as ROM, flash memory, etc.), or some combination of the two. This most basic configuration is illustrated in FIG. 6 by dashed line 606. Further, environment 600 may also include storage devices (removable, 608, and/or non-removable, 610) including, but not limited to, magnetic or optical disks or tape. Similarly, environment 600 may also have input device(s) 614 such as keyboard, mouse, pen, voice input, etc. and/or output device(s) 616 such as a display, speakers, printer, etc. Also included in the environment may be one or more communication connections, 612, such as LAN, WAN, point to point, etc. In embodiments, the connections may be operable to facility point-to-point communications, connection-oriented communications, connectionless communications, etc.

Operating environment 600 typically includes at least some form of computer readable media. Computer readable media can be any available media that can be accessed by processing unit 602 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

The operating environment 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

As will be understood from the foregoing disclosure, one aspect of the technology relates to a system comprising: at least one processor; and memory storing instructions that, when executed by the at least one processor, causes the system to perform a set of operations. The set of operations comprises: receiving a proposal associated with a subscriber, wherein the proposal is associated with an asset; accessing a model, wherein the model is trained based at least in part on historical data associated with the subscriber; generating, using the model, a proposal recommendation for the received proposal; generating a display of the proposal recommendation comprising asset information associated with the asset and information associated with one or more similar proposals to the received proposal, wherein the display further comprises a visual indication of a strength associated with the proposal recommendation and an actions dropdown usable to select an action to perform for the proposal; receiving, from the computing device, an indication to approve or reject the proposal based at least in part on the generated display; and generating a response to the proposal based on the received indication. In an example, the set of operations further comprises: determining whether the indication is contrary to the generated proposal recommendation; based on determining that the indication contrary to the generated proposal recommendation, retraining the model based at least in part on the received indication. In another example, the model is trained based at least in part on historical data associated with one or more other subscribers, and the one or more other subscribers are in a similar industry as the subscriber. In a further example, the one or more similar proposals are identified based on a problem code associated with the received proposal. In yet another example, retraining the model comprises: determining a first subset of the historical data for training the model and a second subset of the historical data for model verification; retraining the model using the first subset of the historical data; and verifying the model using the second subset of the historical data. In a further still example, the display of the proposal recommendation comprises a graphical representation of the proposal recommendation. In another example, the proposal is associated with a contractor; and the display of the proposal recommendation comprises information associated with the contractor.

In another aspect, the technology relates to another system comprising: at least one processor; and memory storing instructions that, when executed by the at least one processor, causes the system to perform a set of operations. The set of operations comprises: receiving an invoice associated with a subscriber; generating a display of the received invoice; providing the generated display to a computing device of the subscriber; receiving an indication from the computing device to approve or reject the received invoice; determining, based on the indication and historical data associated with the subscriber, whether an invoice approval rule may be generated; when it is determined that an invoice approval rule may be generated, generating an invoice approval rule based on the indication and the historical data associated with the subscriber; and storing the generated invoice approval rule. In an example, the set of operations further comprises: receiving a second invoice associated with the subscriber; determining that the generated invoice approval rule applies to the received second invoice; and automatically processing the second invoice based on the generated invoice approval rule. In another example, automatically processing the second invoice comprises one of: automatically approving the second invoice; and automatically rejecting the second invoice. In a further example, the invoice approval rule is generated based on receiving a user indication to generate the invoice approval rule. In yet another example, the generated display comprises a display of additional information regarding similar historical invoices to the received invoice. In a further still example, the similar historical invoices are identified based on a problem code associated with the received invoice.

In a further aspect, the technology relates to another system comprising: at least one processor; and memory storing instructions that, when executed by the at least one processor, causes the system to perform a set of operations. The set of operations comprises: receiving a proposal associated with a subscriber; accessing a model, wherein the model is trained based at least in part on historical data associated with the subscriber; generating, using the model, a proposal recommendation for the received proposal; generating a display of the proposal recommendation; receiving, from the computing device, an indication to approve or reject the proposal based at least in part on the generated display; and generating a response to the proposal based on the received indication. In an example, the set of operations further comprises: determining whether the indication is contrary to the generated proposal recommendation; based on determining that the indication contrary to the generated proposal recommendation, retraining the model based at least in part on the received indication. In another example, the model is trained based at least in part on historical data associated with one or more other subscribers, and the one or more other subscribers are in a similar industry as the subscriber. In a further example, the proposal is associated with an asset of the subscriber. In yet another example, generating the display further comprises incorporating information associated with the asset. In a further still example, generating the display further comprises incorporating information associated with one or more similar proposals to the proposal. In another example, the one or more similar proposals are identified based on a problem code associated with the proposal.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments are described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A system comprising:
at least one processor; and
memory storing instructions that, when executed by the at least one processor, causes the system to perform a set of operations, the set of operations comprising:
receiving a proposal associated with a subscriber, wherein the proposal is associated with an asset;
accessing a model, wherein the model is trained based at least in part on historical data associated with the subscriber;
generating, using the model, a proposal recommendation for the received proposal;
generating a display of the proposal recommendation comprising asset information associated with the asset and information associated with one or more similar proposals to the received proposal, wherein the display further comprises a visual indication of a strength associated with the proposal recommendation and an actions dropdown usable to select an action to perform for the proposal;
receiving, from the computing device, an indication to approve or reject the proposal based at least in part on the generated display; and
generating a response to the proposal based on the received indication.

2. The system of claim 1, wherein the set of operations further comprises:
determining whether the indication is contrary to the generated proposal recommendation;
based on determining that the indication contrary to the generated proposal recommendation, retraining the model based at least in part on the received indication.

3. The system of claim 1, wherein the model is trained based at least in part on historical data associated with one or more other subscribers, and wherein the one or more other subscribers are in a similar industry as the subscriber.

4. The system of claim 1, wherein the one or more similar proposals are identified based on a problem code associated with the received proposal.

5. The system of claim 2, wherein retraining the model comprises:
determining a first subset of the historical data for training the model and a second subset of the historical data for model verification;
retraining the model using the first subset of the historical data; and
verifying the model using the second subset of the historical data.

6. The system of claim 1, wherein the display of the proposal recommendation comprises a graphical representation of the proposal recommendation.

7. The system of claim 1, wherein the proposal is associated with a contractor; and wherein the display of the proposal recommendation comprises information associated with the contractor.

8. A system comprising:
at least one processor; and
memory storing instructions that, when executed by the at least one processor, causes the system to perform a set of operations, the set of operations comprising:
receiving an invoice associated with a subscriber;
generating a display of the received invoice;
providing the generated display to a computing device of the subscriber;
receiving an indication from the computing device to approve or reject the received invoice;
determining, based on the indication and historical data associated with the subscriber, whether an invoice approval rule may be generated;
when it is determined that an invoice approval rule may be generated, generating an invoice approval rule based on the indication and the historical data associated with the subscriber; and
storing the generated invoice approval rule.

9. The system of claim 8, wherein the set of operations further comprises:
receiving a second invoice associated with the subscriber;
determining that the generated invoice approval rule applies to the received second invoice; and
automatically processing the second invoice based on the generated invoice approval rule.

10. The system of claim 9, wherein automatically processing the second invoice comprises one of:
automatically approving the second invoice; and
automatically rejecting the second invoice.

11. The system of claim 8, wherein the invoice approval rule is generated based on receiving a user indication to generate the invoice approval rule.

12. The system of claim 8, wherein the generated display comprises a display of additional information regarding similar historical invoices to the received invoice.

13. The system of claim 12, wherein the similar historical invoices are identified based on a problem code associated with the received invoice.

14. A system comprising:
at least one processor; and
memory storing instructions that, when executed by the at least one processor, causes the system to perform a set of operations, the set of operations comprising:
receiving a proposal associated with a subscriber;
accessing a model, wherein the model is trained based at least in part on historical data associated with the subscriber;
generating, using the model, a proposal recommendation for the received proposal;
generating a display of the proposal recommendation;
receiving, from the computing device, an indication to approve or reject the proposal based at least in part on the generated display; and
generating a response to the proposal based on the received indication.

15. The system of claim 14, wherein the set of operations further comprises:
determining whether the indication is contrary to the generated proposal recommendation;
based on determining that the indication contrary to the generated proposal recommendation, retraining the model based at least in part on the received indication.

16. The system of claim 14, wherein the model is trained based at least in part on historical data associated with one or more other subscribers, and wherein the one or more other subscribers are in a similar industry as the subscriber.

17. The system of claim 14, wherein the proposal is associated with an asset of the subscriber.

18. The system of claim 17, wherein generating the display further comprises incorporating information associated with the asset.

19. The system of claim 14, wherein generating the display further comprises incorporating information associated with one or more similar proposals to the proposal.

20. The system of claim 19, wherein the one or more similar proposals are identified based on a problem code associated with the proposal.
